(19) United States
(12) Patent Application Publication
(10) Pub. No.: US 2015/0379625 A1
(43) Pub. Date: Dec. 31, 2015

(54) System And Method For Administering A Modified Descending Price Auction

(71) Applicant: Alessandro Lorenzo Soldati, Neggio (CH)

(72) Inventor: Alessandro Lorenzo Soldati, Neggio (CH)

(21) Appl. No.: 14/316,713

(22) Filed: Jun. 26, 2014

(51) Int. Cl. G06Q 30/08; G06Q 30/02

(52) U.S. Cl. CPC G06Q 30/08; G06Q 30/0283

(57) ABSTRACT

A system and method for administering a modified descending price auction is disclosed. The method includes setting an initial current price for a quantity of the product and setting of an auction starting and ending time. A processor determines a rate of decrease in the current price. The current price is displayed, repeatedly decreased, and bidding at the current price is enabled. The method includes receiving bids from bidders at the then-current price or lower and then saving the received bids in a database. The method includes selecting a highest bid in the database not marked as ‘winning’. The method compares the highest bid to the then-current price and marks the highest bid as ‘winning’ and decreases a quantity of products when the highest bid equals or exceeds the then-current price. The method includes awarding the product to bidders with bids marked as winning at the current price when at least one of the following occurs: i) the quantity of products equals zero, ii) the ending time of the auction is reached, and iii) the auction is manually stopped.

### FIELD OF THE INVENTION

The present teachings relate to the field of online shopping. In particular, the invention relates to a method and system for conducting an interactive auction over an electronic network.

### BACKGROUND OF THE INVENTION

When companies or stores sell products, they set a price based on an estimate of the price which consumers are ready to pay. Since sellers are the ones setting the price, there is a risk of either overestimating or underestimating how much customers are willing to pay and in turn, not accurately forecasting the demand for the product.

Moreover, when a customer is in an actual shop or is shopping online, they purchase products based on the FIFO method (i.e. first-in, first-out). In other words, the first customer that ‘sees’ the product can buy it, even if the next potential customer is willing and able to pay more. This results in an opportunity loss for shop or website owners when there is limited quantity of products for sale.

As a result, not properly pricing products and misjudging demand can affect the satisfaction of buyers and sellers alike.

Auctions allow the setting of a selling price by potential buyers, also known as bidders. Auctions usually take the form of a physical gathering of bidders assembled together within an auction house. Interested bidders simply appear at the appointed time and place and bid on merchandise in which they are interested. Online auctions enable individuals dispersed over a wide geographic area to participate in the auction.

Typical descending-price auctions, also known as Dutch auctions, are a type of auction that begin with a comparatively high asking price that is steadily decreased until a participant is willing to accept a then-current price by making a bid, or a predetermined reserve price (the seller's minimum acceptable price) is met. Typically, a descending-price auction awards only a single item to the first actual bidder offering the current price leaving participants who simply monitored the auction and choose not to bid at the then-current price empty-handed. As a result, this type of auction can be disadvantageous to those participants who wish to make a desired fixed-value bid but are unable to continually access the auction at the time the current bid price falls to the desired fixed-value. This type of auction can be also disadvantageous to sellers who desire to sell multiple quantities of the same product.

Accordingly, the need exists for a system and method to efficiently set a price for products that can satisfy potential buyers while also allowing the seller to maximize his profits and control demand. The need also exists for as system and method to efficiently sell multiple quantities of the same product in a manner that maximizes profits.

### SUMMARY OF THE INVENTION

The present teachings relate to a method of administering a modified descending price auction and enabling remote bidding over an electronic network via a facilitator. The method includes setting an initial current price for a quantity of the product, an auction starting time, and an auction ending time. The method includes determining, with a processor, a rate of decrease in the current price. The method includes instructing a display to display the current price and enabling bidding at the current price. The method includes repeatedly decreasing and displaying the current price. The method includes receiving bids from bidders at the then-current price or lower and saving received bids in a database. The method includes selecting a highest bid in the database not marked as winning. The method includes comparing the highest bid to the then-current price and marking the highest bid as winning and decreasing a quantity of products when the highest bid equals or exceeds the then-current price. The method includes awarding the product to bidders with bids marked as winning at the current price when at least one of the following occurs: i) the quantity of products equals zero, ii) the ending time of the auction is reached, and iii) the auction is manually stopped.

The present teachings also relate to a method of administering a modified descending price auction. The method includes setting an initial current price for a quantity of the product, an auction starting flint, and an auction ending time; setting an initial current price for a quantity of the product, an auction starting time, and an auction ending time; determining, with a processor, a rate of decrease in the current price; instructing a display to display the current price and enabling bidding at the current price; repeatedly decreasing and displaying the current price; receiving bids from bidders at the then-current price or lower and saving received bids in a database; comparing, for each received bid, the respective bid to the then-current price and reserving the bid and decreasing a quantity of products when the respective bid equals or exceeds the then-current price; and awarding the product to bidders with reserved bids at the current price when at least one of the following occurs: i) the quantity of products equals zero, ii) the ending time of the auction is reached, and iii) the auction is manually stopped.

The present teachings still further relate to a system configured to administer a modified descending price auction for a plurality of products over a network. The system includes a database and at least one processor configured to execute program instructions and to process logic including the following; setting an initial current price for a quantity of the product, an auction starting time, and an auction ending time; determining, with the processor, a rate of decrease in the current price; instructing a display to display the current price and enabling bidding at the current price; repeatedly decreasing and displaying the current price; receiving bids from bidders at the then-current price or lower and saving received bids in the database; selecting a highest bid in the database not marked as winning; comparing the highest bid to the then-current price and marking the highest bid as winning and decreasing a quantity of products when the highest bid equals or exceeds the then-current price; awarding the product to bidders with bids marked as winning at the current price when at least one of the following occurs: i) the quantity of products equals zero, ii) the ending time of the auction is reached, and iii) the auction is manually stopped.

The present teachings yet further relate to a system configured to administer a modified descending price auction for a plurality of product over a network. The system includes a database and at least one processor configured to execute program instructions and to process logic including the following; setting an initial current price for a quantity of the product, an auction starting time, and an auction ending time; determining, with the processor, a rate of decrease in the current price; instructing a display to display the current price and enabling bidding at the current price; repeatedly decreasing and displaying the current price; receiving bids from bidders at the then-current price or lower and saving received bids in the database; comparing, for each received bid, the respective bid to the then-current price and reserving the bid and decreasing a quantity of products when the respective bid equals or exceeds the then-current price; and awarding the product to bidders with reserved bids at the current price when at least one of the following occurs: i) the quantity of products equals zero, ii) the ending time of the auction is reached, and iii) the auction is manually stopped.

Additional features and advantages of various embodiments will be set forth, in part, in the description that follows, and will, in part, be apparent from the description, or may be learned by the practice of various embodiments. The objectives and other advantages of various embodiments will be realized and attained by means of the elements and combinations particularly pointed out in the description herein.

### BRIEF DESCRIPTION OF THE DRAWINGS

FIG. 1 shows a diagram of a computer environment for implementing a modified descending-price auction system according to an embodiment of the present teachings;

FIG. 2 shows a diagram illustrating a method of conducting a modified descending-price auction according to an embodiment of the present teachings;

FIG. 3A shows a table of exemplary parameters corresponding to a product to be auctioned according to an embodiment of the present teachings;

FIG. 3B shows a table of exemplary parameters corresponding to the registration of a potential buyer according to an embodiment of the present teachings;

FIG. 3C shows a table of exemplary parameters corresponding to bid review and validation according to an embodiment of the present teachings;

FIG. 3D shows a table of exemplary parameters corresponding to general system parameters according to an embodiment of the present teachings;

FIGS. 4A-4C show screenshots illustrating the various parameters that can be entered into fields for conducting an auction according to an embodiment of the present teachings;

FIG. 5 shows a screenshot illustrating an exemplary merchandise bidding page according to an embodiment of the present teachings;

FIG. 6 illustrates a diagram illustrating a sub-method for reviewing and validating bids according to an embodiment of the present teachings;

FIG. 7A shows a data-flow illustration of bidding over time for an entire auction that ended upon the entire stock of 4 products being sold;

FIG. 7B shows a data-flow illustration of bidding over time for an entire auction that ended upon the entire stock of 2 products being sold;

FIG. 7C shows a data-flow illustration of bidding over time for an entire auction that ended upon the time for the auction expiring; and

FIG. 7D shows a data-flow illustration of bidding over time for an entire auction that ended manually by a decision of the auctioneer.

It is to be understood that both the foregoing general description and the following detailed description are exemplary and explanatory only, and are intended to provide an explanation of various embodiments of the present teachings.

### DETAILED DESCRIPTION OF THE PREFERRED EMBODIMENTS

The exemplary embodiment of the present teachings provides an electronic auction system and method for presenting merchandise or services (hereinafter ‘products’) for sale at auction to buyers over an electronic network, such as the Internet's World Wide Web. The electronic auction system and method of the present teachings administers a modified descending price auction that allows potential buyers to decide the price they are willing to pay for a product while presenting the possibility of being charged a lower vice as the auction progresses. The modified descending price auction of the present teachings introduces an increased level of fun and emotions into the shopping experience of potential buyers.

According to an exemplary embodiment, potential buyers are presented with one or more descriptive merchandise catalog pages through which they may navigate to find out information about a particular product (i.e. a lot) that is the subject of the auction. At the commencement of the auction, the product is offered to potential buyers at an initial price corresponding to the price of a single product while the total quantity at auction is generally not disclosed. The initial product price is then gradually discounted over time and is referred to as the current price. At any time after the auction commences, buyers can submit a price they are willing to pay to purchase the product up to the current price. After submitting the bid, the electronic auction system records the bid and the auction continues to seek other bids until it closes or ends as a result of various conditions. According to the present teachings, the auction can end when the stock of product is exhausted, the pre-set time period for the auction has lapsed, or the auctioneer has decided to manually stop the auction.

Notwithstanding how the auction is ended, the current price at the end of the auction is the price which all bidders who bid a higher price for the product will have to pay. The modified descending price auction of the present teachings can notify the winning and losing bidders by electronic mail. The auction of the present teachings can also post a list of the winning bidders on the closed lot's merchandise catalog page.

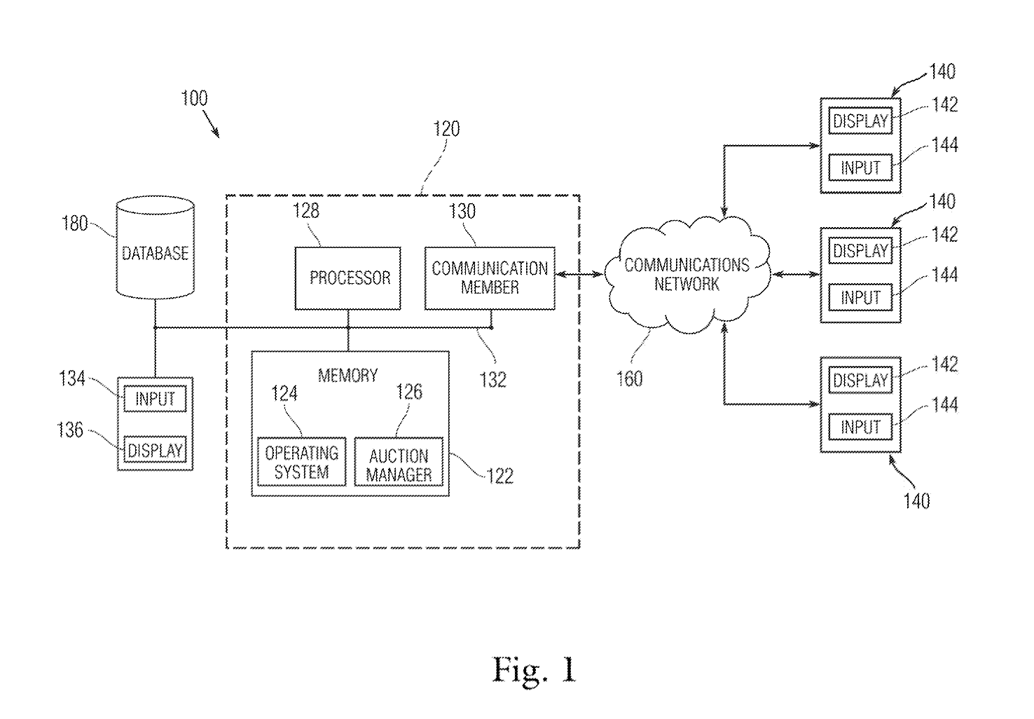

Referring to FIG. 1, a remote auction bidding system and method 100 are shown for conducting the modified descending-price auction according to an embodiment of the present teachings. The system and method 100 shown in FIG. 1 are for illustrative purposes only and any other suitable systems, methods, subsystems, or sub-methods could be used in conjunction with or in lieu of the system and method 100 according to an embodiment of the present teachings.

The system and method 100 allow a plurality of remote participants 140 to communicate and interact with an auction server 120 through a communications network 160. An exemplary communications network 160 for implementing the present invention is the Internet which is accessible by a significant percentage of the world population, although the network may also be a local area or limited area accessible network.

The auction server 120 can include a computer system having a memory 122, at least one processor 128, and a communication member 130. Each element of the auction server 120 can be coupled to a bus 132 or other communication mechanism for relaying information.

A memory 122 can include both random access memory (RAM) and read-only memory (ROM). The memory 122 can be employed to store program information, instructions to be executed by a processor 128, and temporary information during execution of instructions by the processor 128.

Within the memory 122 can reside an operating system 124 and an auction manager 126. The operating system 124 can be employed as a software platform upon which the modified descending-price auction application program can execute. The auction manager 126 can include program instruction sequences (i.e. a computer program) for managing the modified descending-price auction of the present teachings.

The processor 128 can be employed to execute the program instructions that are stored in memory 122. The processor 128 can be capable of identifying and monitoring each remote participant 140 as well as communicating with each remote participant 140 via the communication member 130 and the communications network 160.

The communication member 130 can include conventional hardware and software that administers coupling the auction server 120 to the communications network 160.

According to an embodiment of the present teachings, the auction server 120 can be coupled to a database 180. The auction server 120 can store parameters associated with one or more products being auctioned in the database 180. The parameters stored in the database 180 can include product descriptions, initial price, low price (i.e. reserve price), auction start and end times, price drop parameters, bid information, and the like. The auction server 120 can also store information corresponding to participants or potential buyers in the database 180.

The auction server 120 can also be coupled to at least one input device 134, to allow an auctioneer (i.e. any person running the auction) to communicate auction instructions and parameters, and at least one display 136, to display information to an auctioneer, according to an embodiment of the present teachings.

Remote participants 140 can access auction information by communicating with auction server 120 through the communications network 160. Each remote participant 140 can include at least one display 142, to view auction items and associated information, and at least one input device 144, to communicate with the auction server 120.

Any of the input devices 134, 144 can include an alphanumeric keyboard, mouse, trackball, cursor direction keys, touch pad, Touch Tone telephone, wireless telephone, two-way pager, personal digital assistant, voice recognition device, other suitable data input device, or any combination thereof.

Any of the displays 136, 142 an include a cathode ray tube (CRT) monitor, liquid crystal display (LED) monitor, plasma screen, high definition television (HDTV) screen, light emitting diode (LED) monitor, conventional television screen, projection television screen, video conferencing display, other suitable display, or any combination thereof.

The present teachings are related to the use of the auction server 120 to administer a modified descending-price auction according to the present teachings. According to an embodiment, execution of the instructions stored in memory 122 allows processor 128 to implement the functionality described above. According to alternative embodiments, hardware circuitry can be used in conjunction with or in lieu of software instructions to implement the present disclosure. However, the present teachings are not limited to any specific combination of hardware circuitry and/or software.

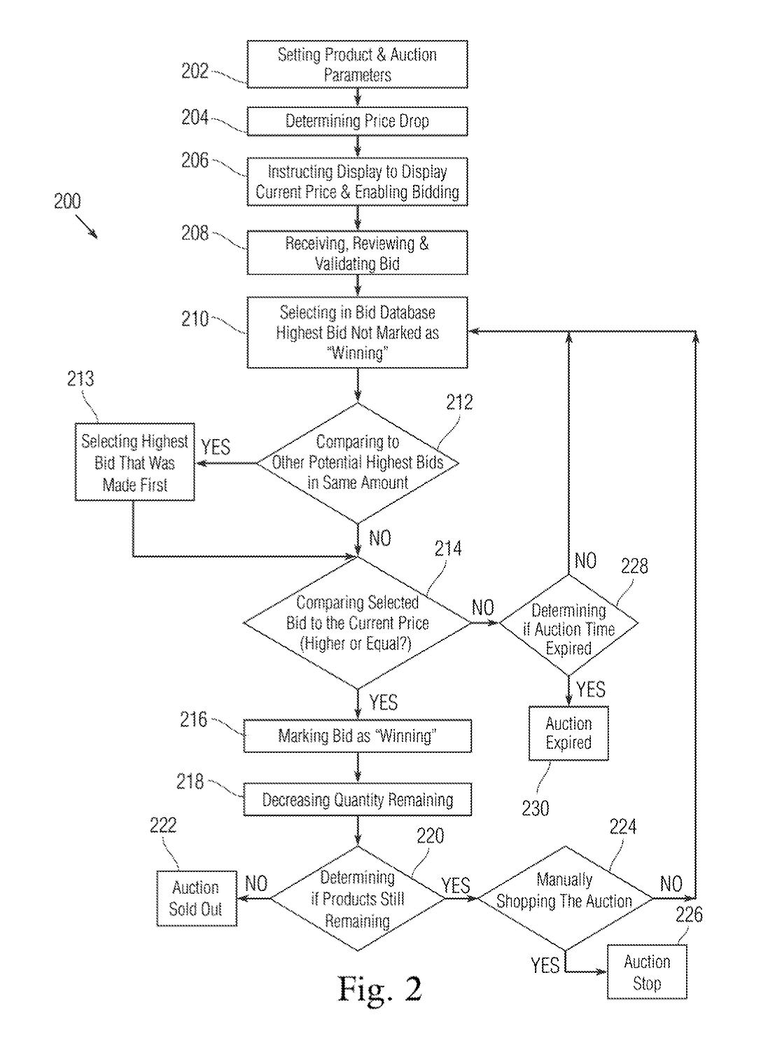

FIG. 2 is a flow diagram illustrating a method 200 of administering the modified descending-price auction according to an embodiment of the present teachings. It should be understood that the method 200 shown in the figures is for illustrative purposes only and that any other suitable method, or sub-method could be used in conjunction with or in lieu of method 200 according to an embodiment of the present teachings. It should also be understood that the operations of the method 200 could be performed in any suitable order or manner using various hardware and software.

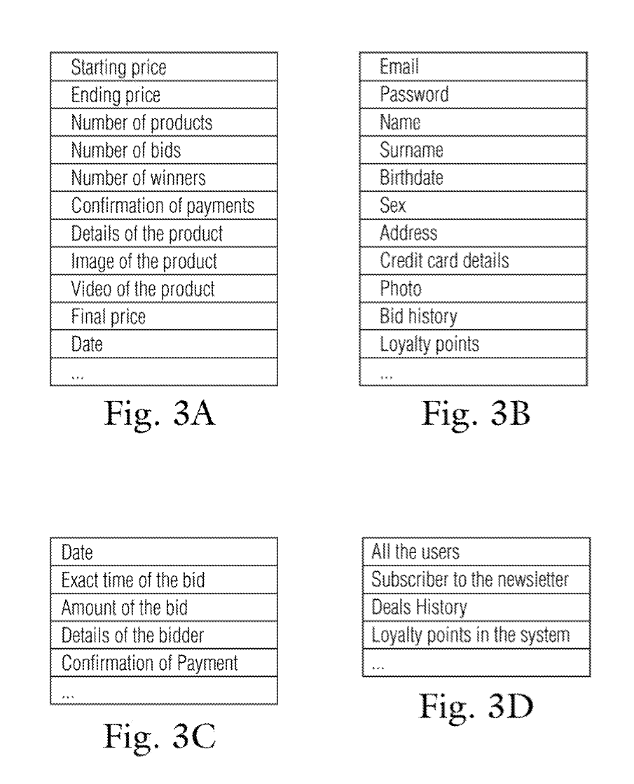

In an embodiment the method 200 begins at operation 202 with the auction manager 126 requesting an auctioneer to designate various parameters associated with a product to be auctioned using the modified descending price auction. For example, this could include setting an initial current price for a quantity of the product, an auction starting time, and an auction ending time. The parameters can generally include the initial price, the lowest acceptable price (i.e. the reserve price), the quantity of product available, the time period for the auction, and how much the price will decrease per unit time. FIG. 3A shows various exemplary parameters that can be obtained and stored in the database 180 by the auction manager 126 for each auctioned lot during operation 202.

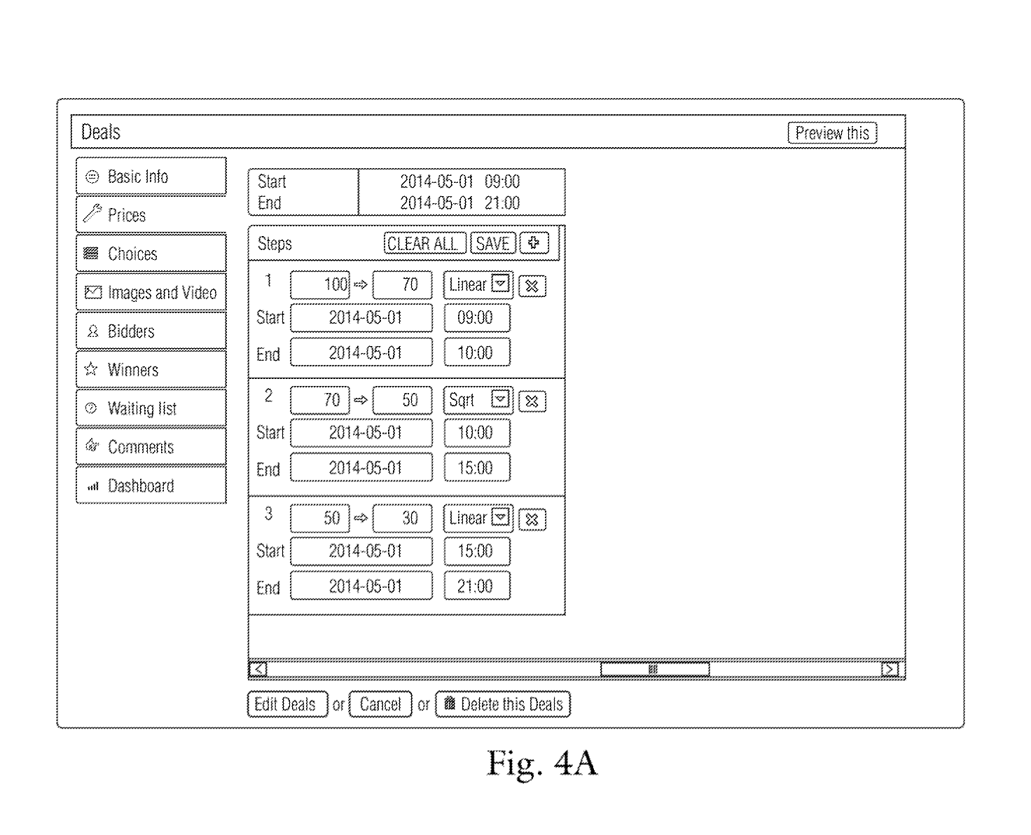

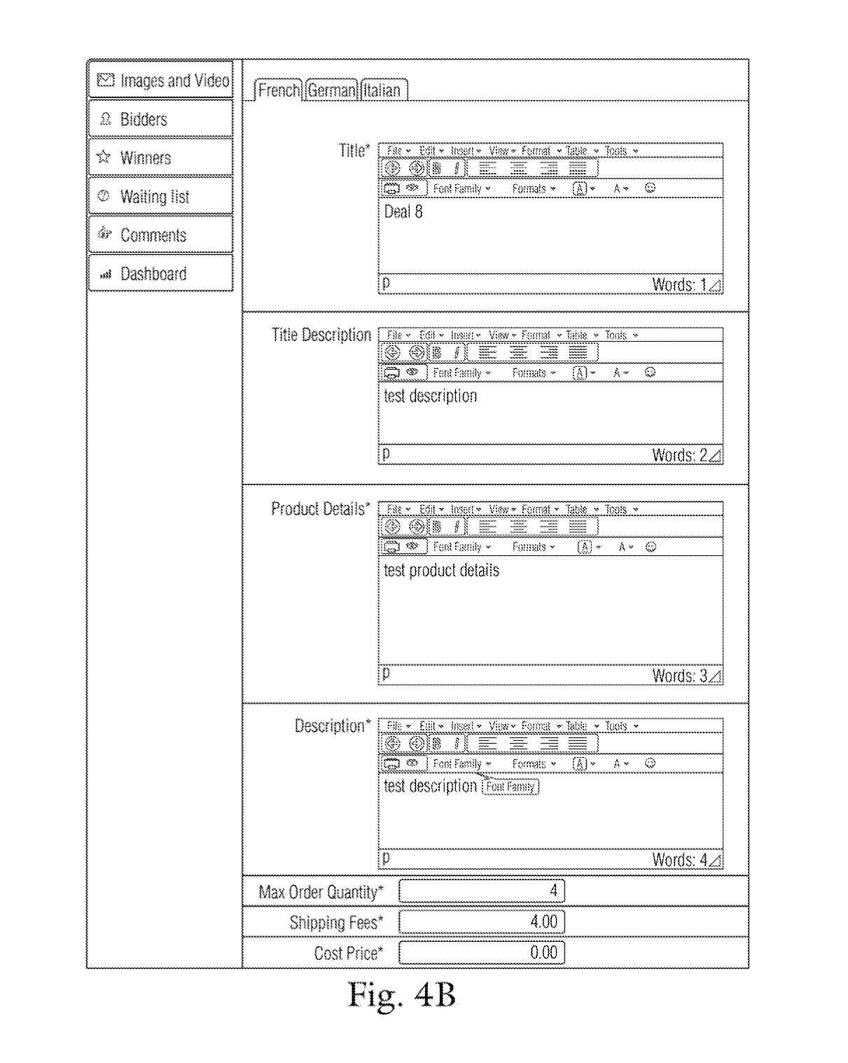

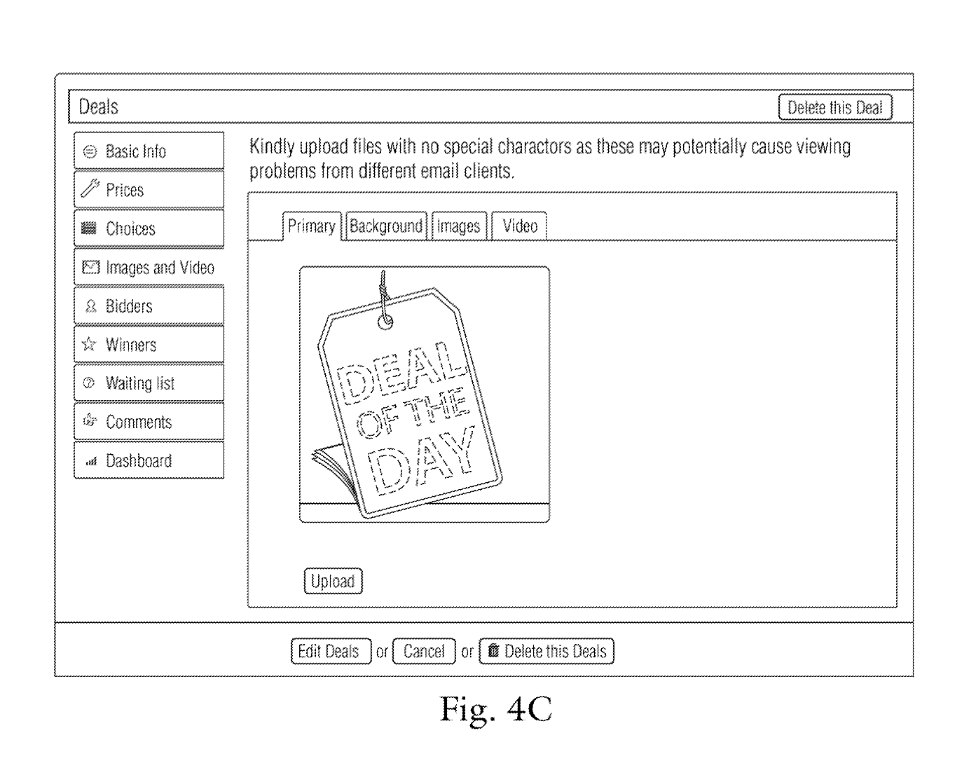

FIGS. 4A-4C show screenshots illustrating the various parameters that can be entered into fields for conducting an auction. The auctioneer is allowed to choose the starting auction price, the starting and ending times of the auction, how much the price will decrease per unit time, how often the price will tick downward, product descriptions including photos and videos, and the like. The auctioneer can optionally choose a minimum price for the product. The auction system and method 200 allows the auctioneer to choose how long the auction will last even though the auctioneer can decide to stop the auction before the chosen ending time, as will be discussed in more detail below.

The starting or initial auction price of the designated product can be the usual market price. The initial auction price can also include the costs of shipping and handling and/or taxes. In this way, the initial auction price will not include any additional costs to the ultimate buyer or buyers.

The quantity of the designated product being offered for sale can also be chosen by the auctioneer. The number of items of the same products may range from one to many depending on the auctioneer. The number of items being offered may or may not be withheld from the potential buyers before or during the auction, but can be generally withheld.

Referring back to FIG. 2, in operation 204, the auction manager 126 can analyze the user-inputted parameters and can calculate the price drop rate. For example, this can include determining, with the processor 128, a rate of decrease in the current price.

According to various embodiment, the auction manager 126 can calculate a standard drop rate with an algorithm that is based on price and time. For example, if an item has an initial price of $125.00, a reserve price of $25.00, and an auction time period of 12 hours, the standard drop rate would be $0.1388 per minute ($100 divided by 720 minutes in 12 hours). Of course, it may be desirable to round the drop rate to the nearest cent per unit of time, in this case $0.14 per minute. In this example, the price drop rate is linear, but the rate could be exponential, logarithmic, or a combination of one or more of these price drop rates according to various embodiments and as desired by the auctioneer.

In another embodiment, the user-inputted parameters can direct the auction manager 126 to adjust the price drop rate using an algorithm such that the price drop rate prior to decreasing to a predetermined intermediate value, such as $50 in the above example, would be greater than the price drop rate once the predetermined value has been reached. In yet another embodiment, more than one predetermined intermediate value could be selected such that the price drop rate is adjusted multiple times throughout the auction based on user-selected criteria. For example, as each progressively lower intermediate value is reached, the price drop rate (and or the multiplying factor employed by auction manager 126) could be progressively decreased in order to extend the life of the auction and thereby increase the likelihood of a bid.

In alternate embodiments, auction manager 126 be directed to adjust the price drop rate with an algorithm that manipulates the standard drop rate based on the number of viewers of the product. By way of example but not limitation, if no participant has viewed the item in a predetermined time frame, such as 5 minutes, then the price drop rate may decrease to 0 (or close to 0). This functionality can substantially prevent items from losing significant value at times where few, if any, participants are actively engaged in the auction—for example, at very late hours of the night or holidays. Conversely, if a predetermined number of people, such as 5 people, have viewed the item in a predetermined time frame, such as 5 minutes, then the price drop rate will increase by a predetermined multiplier, such as 1.5× the standard drop rate.

As the above makes clear, the price drop rate can be determined by the auction manager 126 in a number of different ways and using any suitable scheme or algorithm for adjusting and/or controlling the decrease in price over time without deviating from the scope of the present teachings.

In operation 206, auction manager 126 engages the auction by displaying the product, product description, and a current asking price equal to the initial price defined by the user-inputted parameters. This could induce instructing a display 142 to display the current price and enabling bidding at the current price.

Typically the auction manager 126 would not instruct to display the reserve puce but it could be displayed if it were deemed desirable for the remote participants 140 to know the reserve price.

The auction manager 126 enables potential buyers to bid on the product at auction at the current price, such as by instructing to display an appropriately labeled selectable or clickable box or button next to the displayed current price.

As the auction runs, the auction manager 126 operates by repeatedly decreasing and displaying the current price on the displays 140.

The auction manager 126 could also instruct to display a way to allow potential buyers to choose the quantity of products they want to purchase. While a potential bidder could be allowed to choose any quantity of products to bid on or could be capped at a maximum quantity, for purposes of simplicity in this disclosure the bidding quantity for each bidder will be kept locked at one.

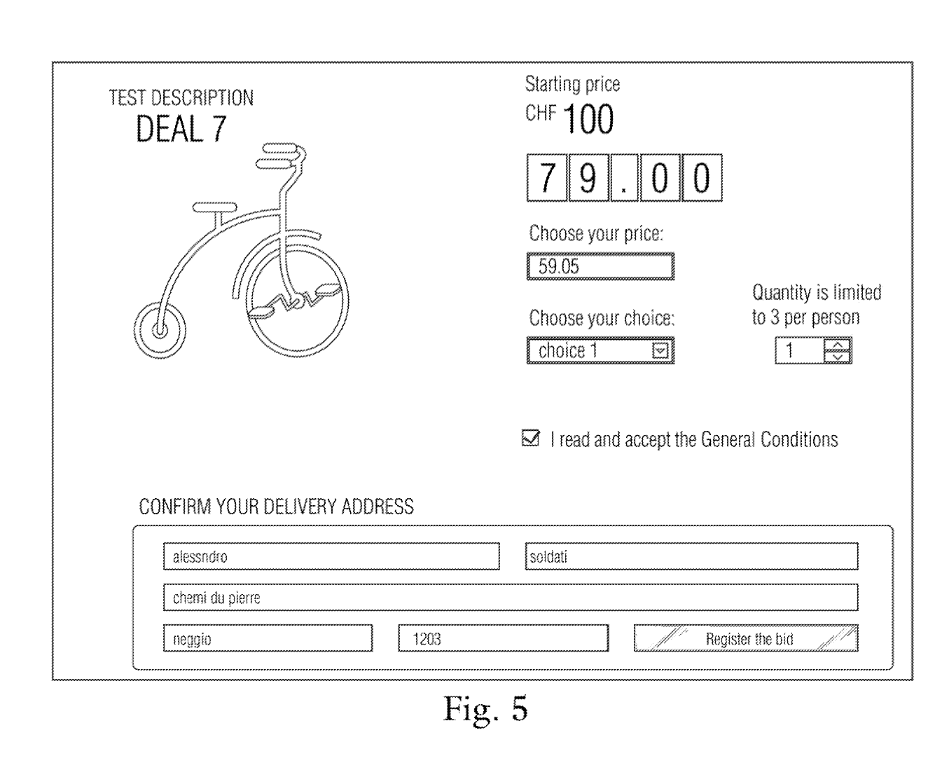

FIG. 5 shows a screenshot illustrating an exemplary merchandise bidding page as viewed by potential bidders while the auction is running. The merchandise bidding page can show the starting auction price of the product and a ticker showing the price sequentially decreasing (i.e. the current price) once the auction has started. The merchandise bidding page can also include a field that allows potential buyers to submit a bid. In the illustrated example, the field is labeled ‘Choose Your Price’. The merchandise bidding page can also include a way to choose the quantity of products to purchase, as well as descriptive information about the product at auction, including one or more photos or videos. The merchandise bidding page can include a way to confirm registration information of potential buyer. For example, the merchandise bidding pave could request entry of bidder's delivery address.

Upon submitting the bid, each bid can go through a bid validation process by the auction manager 126 to ensure the bid is valid before the bid is saved in the database 180.

Potential buyers are generally registered in the database 180 by the auction manager 126 before the start of the auction so that bid entry can be accomplished quickly and easily. However, the registration process could be undertaken at the time of bid entry according to various embodiments. Registration can include obtaining and verifying various information from a potential bidder and storing that information in the database 180.

FIG. 3B shows various exemplary parameters that can be obtained and stored for each potential buyer during the registration process. The parameters can include various required information and various optional information. Required information can include the potential buyer's full name, e-mail address, billing and shipping address, proper state abbreviation, zip code, telephone number, facsimile number, and the like. Optional information can include verified credit card information, as well as various personal data, such as, for example, sex, age, profession, residence, a photo, and the like. While credit card information can be obtained and verified at the time the winners of the auction are notified, credit card information could be obtained and/or verified during the registration process before a bid is submitted. In this way, the credit card of winning bidders could be charged at the time of notification of a winning bid.

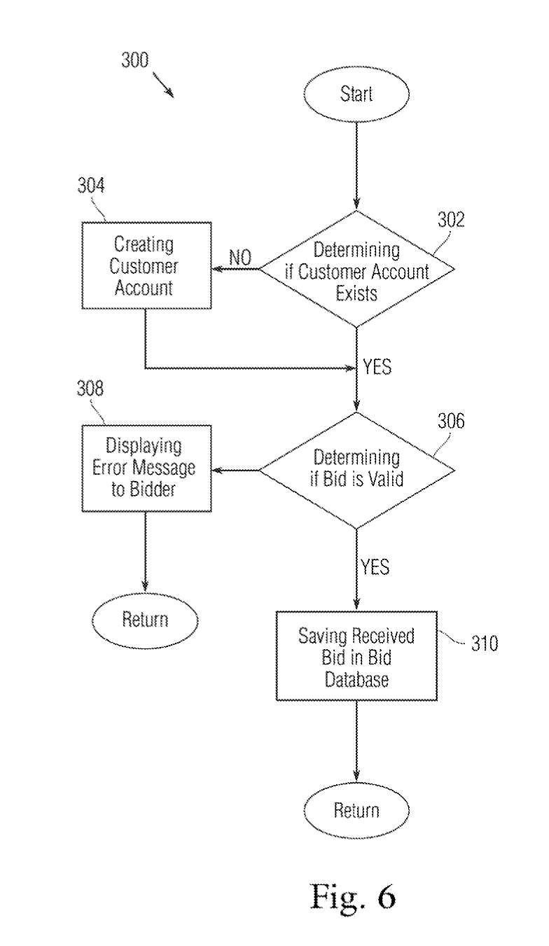

FIG. 6 illustrates a method 300 that the auction manager 126 can implement for reviewing and validating bids that have been entered during operation 208. While potential buyers are generally pre-registered, bid review and validation can begin at operation 302 with the auction manager 126 querying the database 180 and determining whether a customer record or account exists (i.e. that the potential buyer is registered). If an account does not exist, at operation 304 the auction manager 126 directs the potential buyer in creating a new customer account. The new customer account is saved in the database 180 when the registration process is complete.

Once it has been established that the potential buyer is registered, the auction manager 126 can determine if the bid is valid at operation 306. The auction manager 126 can determine if a bid is valid by checking whether the bid is properly formatted, all necessary data is present, and the data values entered look credible. If the bid is invalid, at operation 308 the auction manager 126 can instruct a display 142 to display an error message to the potential buyer and the potential buyer can be prompted to re-submit their bid. Once the bid information has been determined to be valid by the auction manager 126, at operation 310 the bid is saved and entered into the database 180. A validated bid can include the name of the bidder, the time of the bid, as well as other parameters. For example, FIG. 3C shows various parameters that can be obtained and stored in the database 180 by the auction manager 126 for each validated bid during the bid receiving, reviewing, and validating operation 208 of method 200. Other equivalent means for receiving, reviewing and validating bids could be used, as understood by those skilled in the art to which the present teachings pertain.

FIG. 3D shows various parameters that can be obtained and stored in the database 180 by the auction manager 126 at any time during use of the system and method 100 of the present teachings.

A potential buyer can present a single bid for the product being auctioned. The bid can be a value between 0 and the current price of the auctioned product. However, a potential buyer can enter a bid for various quantities of the product at auction. As will be discussed in more detail below, irrespective of how the auction ends, the potential buyer is guaranteed that if he is the winning bidder he will only pay up to his bid price, but the final price paid could be lower depending on how long the auction proceeds and how it ends. As a result, with the modified descending price auction 100 of the present teachings potential buyers are completely in control of their risk.

While the auction is running and until the auction is stopped, bids can be submitted and saved in the database 180 continuously as discussed above. Simultaneously, the auction manager 126 performs several additional operations until the auction is stopped as discussed in more detail below.

Referring back to FIG. 2, in operation 210, the auction manager 126 can query the database 180 and can select the highest bid not marked as ‘winning’. For example, this can include selecting a highest bid in the database not marked as ‘winning’. A ‘winning’ bid is a bid that has been saved in the database 180 that is equal to or higher to the current price of the product being auctioned. A ‘winning’ bid can be designated in any distinguishing manner in the database 180 so as to be differentiated from a regular saved bid in the database 180.

In operation 212, the auction manager 126 then checks to see if any other potential buyers have submitted a bid in the same amount as the selected highest bid of operation 210. For example, this can include comparing the selected highest bid to all other bids saved in the database 180 to determine if any other bids are in the same amount. This can be achieved by the auction manager 126 querying the database 180 and determining if any other potential buyer has submitted a non-‘winning’ bid equal to the selected highest non-‘winning’ bid of operation 210. If yes, at operation 213 the bid that was made first in time is selected by the auction manager 126 for further processing. If there are no other bids equal to the selected non-‘winning’ bid, the auction manager 126 proceeds directly to operation 214.

At operation 214, the auction manager 126 compares the selected non-‘winning’ bid to the current price. For example, this can include comparing the highest bid to the then-current price.

If the selected non-‘winning’ bid is equal to or higher to the current price, the auction moves to operation 216. At operation 216, the auction manager 126 then marks the selected bid as a ‘winning’ bid and saves it as sixth in the database 180. For example, this can include marking the highest bid as winning. The person who submitted this ‘winning’ bid will receive the product at their bid price or at a lower price depending on how the auction bidding proceeds.

Next, at operation 218, the auction manager 126 decreases the quantity of the remaining product by one and saves this parameter in the database 180. For example, this can include decreasing a quantity of products when the highest bid equals or exceeds the then-current price.

At operation 220, the auction manager 126 then determines if there is any product remaining. If the auction manager 126 determines that there is no product remaining, the auction manager 126 stops the auction at operation 222.

At operation 222, the auction is stopped and the product is awarded to all ‘winning’ bidders at the current price (i.e. the price displayed at the time the auction is stopped). For example, this can include awarding the product to bidders with bids marked as ‘winning’ at the current price.

If at operation 220 the auction manager 126 determines that there is product remaining, the auction proceeds to operation 224.

At operation 224, the auction manager 126 provides an opportunity for the auctioneer to manually stop the auction. The auctioneer can decide to stop the auction at any time if it is in their best interest to do so based on the bidding history of the currently running auction.

If the auctioneer decides to manually stop the auction at operation 224, the auction is stopped at operation 226 and the product is aided to all ‘winning’ bidders at the current price at the time the auction is stopped (i.e. the price displayed at the time the auction is stopped). For example, this can include awarding the product to bidders with bids marked as ‘winning’ at the current price.

If the auctioneer decides not to manually stop the auction at operation 224, the auction proceeds back to operation 210. That is, the auction proceeds back to operation 210 where the auction manager 126 again queries the database 180 and selects the highest bid not marked as ‘winning’ and repeats the algorithm until the auction is ended.

However, returning back to operation 214, if the selected non-‘winning’ bid is not equal to or higher to the current price at this operation, the auction moves to operation 228. At operation 228, the auction manager 126 determines whether the time for the auction has expired.

If the auction manager 126 determines that the auction time has not expired at operation 228, the auction manager 126 goes back to operation 210. That is, the auction proceeds back to operation 210 where the auction manager 126 again queries the database 180 and selects the highest bid not marked as ‘winning’ and repeats the algorithm until the auction is ended.

If the auction manager 126 determines that the auction time has expired at operation 228, the auction manager 126 stops the auction at operation 230 and awards the product to all ‘winning’ bidders at the current price at the time the auction time expired (i.e. at the reserve price set by the auctioneer at the beginning of the auction).

Accordingly, the system and method of administering a modified descending price auction 100 of the present teachings can be ended under three scenarios, as shown at operations 222, 226, and 228. That is, the auction can be ended when i) the stock of product is exhausted as shown at operation 222, ii) the pre-set time period for the auction has lapsed as shown at operation 230, and iii) the auctioneer decides to manually stop the auction as shown at operation 226.

Under any of these ending scenarios, the potential buyer is guaranteed that if he is the winning bidder he will only pay up to his bid price, but the final price paid could be much lower. The final price paid is lower anytime the auction ends under any of the three described ending scenarios if the auction continues to run after the potential buyer submits their ‘winning’ bid. The longer the auction continues after a winning bid is submitted, the lower the final paid price will be. As a result, the auction system and method 200 of the present teachings allows potential buyers to be completely in control of their risk since the buyer decides the maximum they are willing to pay.

The auction manager 126 can provide all ‘winning’ bidders with a limited time to pay for the product or products. If the ‘winning’ bidders do not come up with payment within the limited time, they can lose the opportunity to buy the product, and their user account could be blocked. Alternatively, the auction manager 126 could automatically bill the credit cards of all ‘winning’ bidders at the end of the auction. Of course, the credit card information would be required to be entered and validated before any bids could be submitted under an automatic billing system.

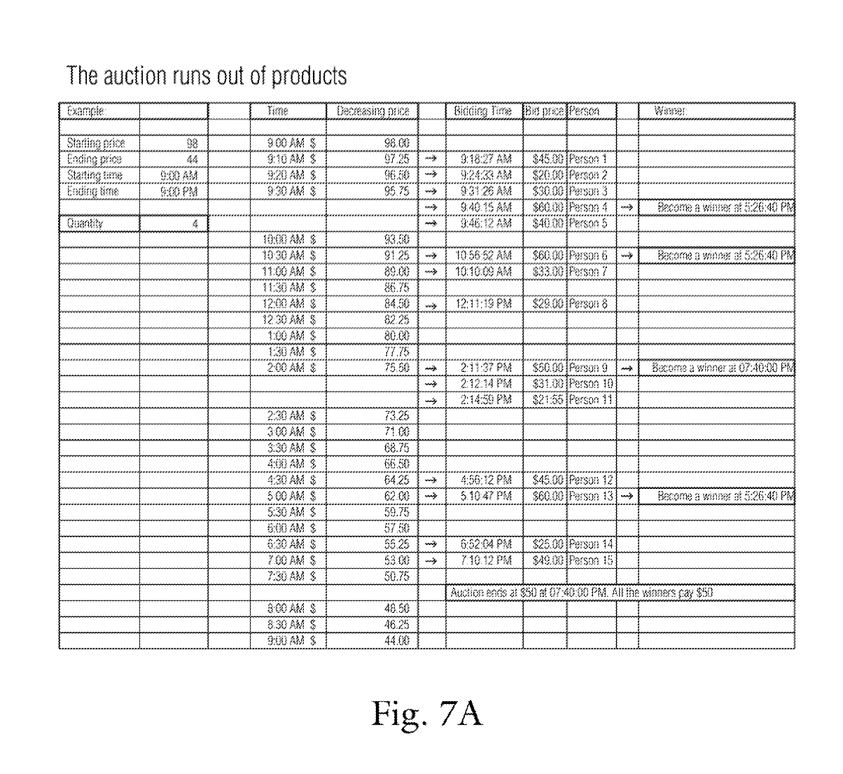

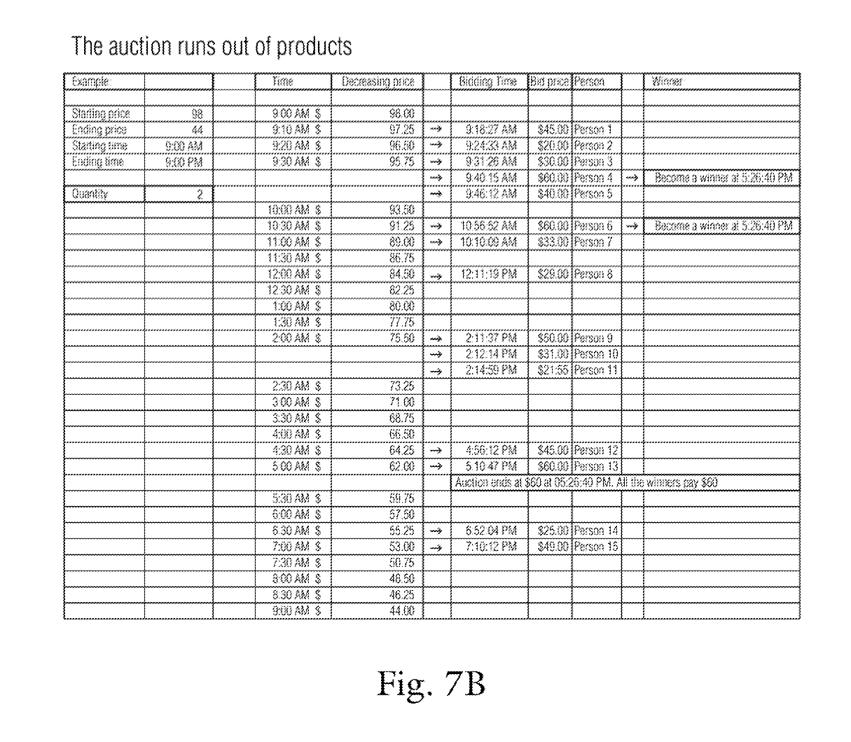

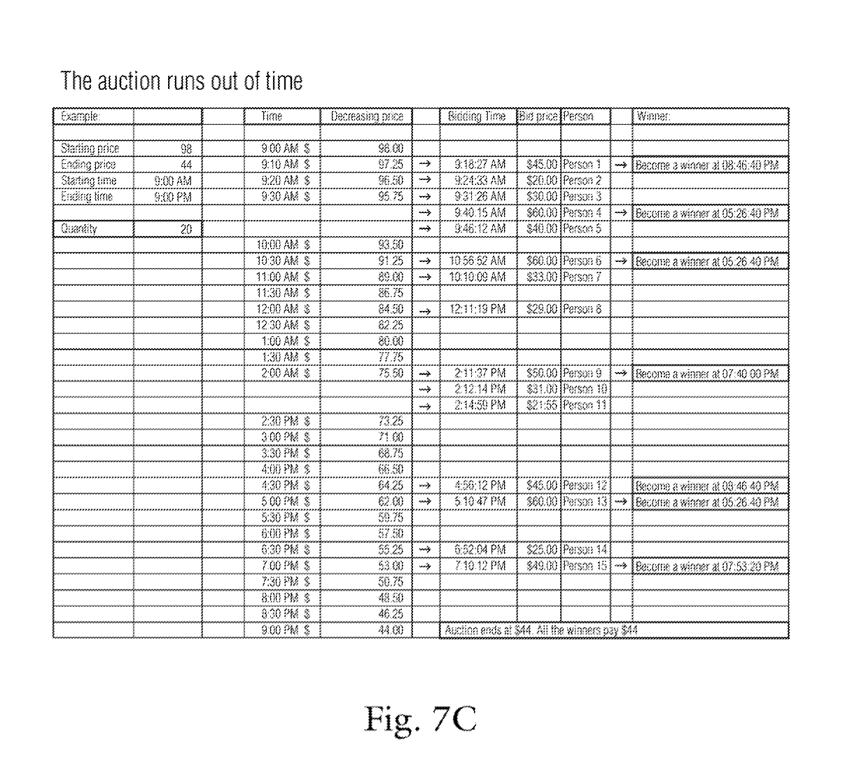

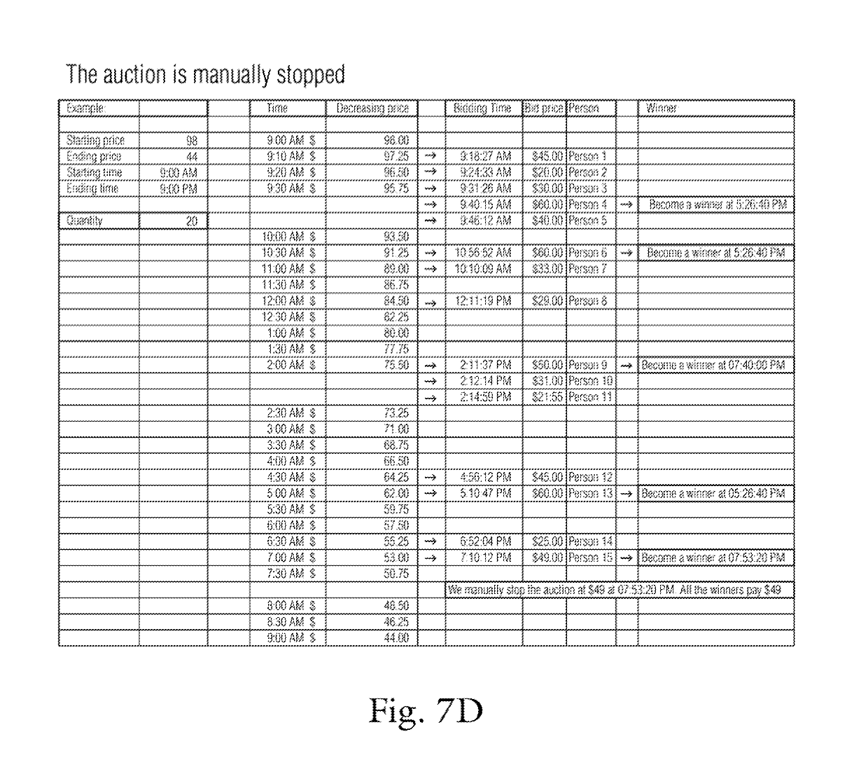

FIGS. 7A to 7D each show a data-flow illustration of bidding over time for an entire auction. This data could be saved in the database 180 and each represent different auction ending scenarios. For each of these sample auctions, starting and ending prices, starting and ending times, and the price drop rate are the same. That is, in each auction, the initial market price of the auctioned product was set for $98 and the minimum price was set for $44. The auction was set to run from a starting time of 9 am to an ending time of 9 pm. The set decrease in price of $54 over the 12 hour period corresponded to the potential buyers seeing the price decrease 75 cents every 10 minutes.

However, for each scenario the quantity of the product being sold was varied in order to help illustrate a particular ending scenario.

Referring to FIG. 7A, the data-flow is shown for an auction that ended at 7:40:00 pm when the last product of the entire stock of 4 products was sold. The data-flow illustrates that as the current price gradually dropped, validated bids were submitted by potential buyers and were saved in the database 180 with the bidding time, the bid price, and the bidder's name. With the system and method 100 of the present teachings, as the auction manager 126 came across a highest bid that corresponds to the current price, the bid was marked as ‘winning’ in the database 180 and the product was reserved for that bidder. In this regard, three bids were initially reserved as ‘winning’ for Persons 4, 6, and 13 at 5:26:40 pm when the current price reached $60, and the forth and last bid was marked as ‘winning’ for Person 9 at 7:40:00 pm when the current price reached $50. At the time when the fourth and last piece of available stock was reserved and the corresponding bid was marked as ‘winning’ (i.e. at 7:40:00 pm), the auction was stopped and the price that was showing (i.e. $50) associated with the last item reserved, was the price that all winning bidders (i.e. Persons 4, 6, 9, and 13) who bid the same or higher price for the product were billed to pay.

Referring to FIG. 7B the data-flow is shown for an auction that ended at 5:26:40 pm when the last product of the entire stock of 2 products was reserved (with the winning bidders being the two bidders who placed their bids earlier in time). In this auction, the auction manner 126 came across three highest bids (Persons 4, 6, and 13 for $60) that correspond to the current price, $60, at 5:26:40 pm. Since there were only 2 products at auction, the auction manager 126 awarded the products to the two bidders that were first in time, that is, to the bids submitted by Persons 4 and 6.

Referring to FIG. 7C, the data-flow is shown for an auction that ended when the auction for a quantity of 20 products ran out of time at 9:00 pm with product still remaining. In this auction, the auction manager 126 came across three highest bids (for Persons 4, 6, and 13 for $60) that correspond to the current price, $60, at 5:26:40 pm and reserved 3 products for these bidders. The auction manager 126 continued the auction since 17 products still remained. A fourth product was then reserved as ‘winning’ for Person 9 at 7:40:00 pm when the current price reached $50. Again, the auction manager 126 continued the auction since 16 products still remained. A fifth product was then reserved as ‘winning’ for Person 15 at 7:53:20 pm when the current price reached $49. Yet again, the auction manager 126 continued the auction since 15 products still remained. A sixth product was then reserved as ‘winning’ for Persons 1 and 12 at 8:46:40 pm when the current price reached $45. And yet again, the auction manager 126 continued the auction since 13 products still remained. However, the auction manager 126 stopped the auction at 9:00 pm when time for the auction ran out. Since the auction ran out of time, the auction manager 126 stopped the auction at that time and the price that was showing (i.e. $44) corresponding to the low puce chosen by the auctioneer at the beginning of the auction, was the price which all 7 winning bidders (i.e. Persons 1, 4, 6, 9, 12, 13, and 15) who bid the same or higher price for the product were billed to pay.

In this situation, all ‘winning’ bidders received the product at the current price when the time for the auction ran out. However, if there are no bids higher than the minimum price selected by the auctioneer, there are no winning bids and no products are sold.

Referring to FIG. 7D, the data-flow is shown for an auction that ended when the auction for a quantity of 20 products was manually stopped by the auctioneer at 7:53:20 pm when the current price shown was $49. In this auction, the auction manager 126 came across three highest bids (for Persons 4, 6, and 13 for $60) that correspond to the current price, $60, at 5:26:40 pm and reserved 3 products for them. The auction manager 126 continued the auction since 17 products still remained. A fourth product was then reserved as ‘winning’ for Person 9 at 7:40:00 pm when the current price reached $50. Again, the auction manager 126 continued the auction since 16 products still remained. A fifth product was then reserved as ‘winning’ for Person 15 at 7:53:20 pm when the current price reached $49. Yet again, the auction manager 126 continued the auction since 15 products still remained. However, the auctioneer decided it was in his interest to stop the auction at 7:53:20 pm when the current price was $49, even though there was still 15 products and time remaining. Since the auction was stopped, the current price showing of $49 at the time the auction was stopped is the price which all 5 winning bidders (i.e. Persons 4, 6, 9, 13, and 15) who bid the same or higher price for the product were billed to pay.

The auctioneer can manually stop the auction at any time and for any reason and force the auction manager 126 to award the product(s) to all ‘winning’ bidders at the current price at the time the auction is stopped (i.e. the price displayed at the time the auction is stopped). For example, manually stopping the auction by the auctioneer can be based on calculating, with the processor 128, a highest profit using the current price and the reserved bids stored in the database 180. In the example of FIG. 7D, it was determined by the auctioneer that it was preferable to sell five products at $49 compared to selling seven products at $44 (the scenario of FIG. 7C), which would have been the likely situation if the auction were to continue until 9:00 pm.

The system and method of administering a modified descending price auction 100 of the present teachings allows an auctioneer to manage demand and to establish the correct market price for all types of products. It eliminates the disadvantages of the FIFO method (i.e. first-in, first-out) that is used in actual stores, where the first person who buys the product prevents others from buying the product at a higher profit margin. It removes the risk of normal auctions, where the price of the product is directly determined by the demand. In the system and method of the present teachings, the auctioneer can establish the purchase price of the product by watching the demand during the auction. At the same time, potential buyers can enter bids at the price they are willing to pay with the knowledge that they could be outbid, while hoping that the current price of the auction stops below their bid (thereby reducing the price they are required to pay). This introduces a new level of excitement and emotions into the buying process.

According to various embodiments, the system and method 100 of the present teachings can include one or more algorithms that can be used to provide the auctioneer with real-time calculations of profit based on the currently displayed price and the bid history up to the current time of the auction. In this way, the auctioneer can be presented with real-time data so that an educated decision can be made at any time whether it is in their best interests to end the auction or whether they should allow the auction to run until the pre-set ending time. The auctioneer can be allowed to track the complete bid history and can be presented with real-time calculations and scenarios showing how many products could be sold and for what price, thereby assisting the auctioneer in determining the best selling price to maximize profit. Allowing the auctioneer to stop the auction at any time provides the ability to control the quantity of product that can be sold, as well as the profit margin.

It will be understood by those skilled in the art that the system and method 100 of the present teachings can save a broad range of data in the database 180 that can be valuable to merchants and manufacturers for predicting consumer demand on a product-specific basis. In this regard, the present teachings can offer a variety of tools to merchants to automate and improve their understanding of the market for their products, including historical consumer information and demand patterns. The data gathered by the auction manager 126 could be presented and manipulated in a variety of ways to provide one or more market analysis tools that could be provided to merchants and manufacturers for a fee.

Since potential buyers are required to register before placing a bid, the system and method of the present teachings captures information on all auction participants so the types of consumer who could be targeted with direct or indirect marketing in the future can be known. In one embodiment, merchants and manufacturers could be provided with an opportunity to purchase contact information data and/or pricing data from the auction manager 126. This information could be used by merchants and manufacturers to send targeted offers directly to potential bidders to drive demand to that merchant or manufacturers. Data about user behavior can be used to provide opportunities for merchants and manufacturers to manage their sales yields by identifying and targeting latent consumer demand for specific products.

Captured data can include the total number of unique bidders that have viewed a product, the bid prices offered, the number of ‘winning’ bidders, and the ‘winning’ price. The system and method 100 of the present teachings can use this type of data to generate a demand curve illustrating to merchants and manufacturers the impact of a price change on demand, plotted over time for their product. Accordingly, the ability of the system to provide merchants with a detailed breakdown of existing consumer demand based on a broad range of information such as price-point continuum, can enable merchants to input targeted promotions specifically designed to stimulate consumer demand to their product. Merchants and manufacturers can use this ability to deliver promotions in real-time to target promotions with extraordinary precision to consumers who are actively seeking a product that meets known specifications. It also enables manufacturers to efficiently optimize and vary then promotional spending based on consumer purchase intent, rather than making promotions broadly available to the public.

Accordingly, a broad range of data saved in the database 180 can be extremely valuable to merchants and manufacturers. This data could be billed to merchants and manufacturers in whole, or could be billed separately in parts to increase the value of the data.

Those skilled in the art can appreciate from the foregoing description that the present teachings can be implemented in a variety of forms. Therefore, while these teachings have been described in connection with particular embodiments and examples thereof, the true scope of the present teachings should not be so limited. Various changes and modifications may be made without departing from the scope of the teachings herein.

What is clamed is:

1. A method comprising:
setting an initial current price for a quantity of the product, an auction starting time, and an auction ending time;
determining, with a processor, a rate of decrease in the current price;
instructing a display to display the current price and enabling bidding at the current price;
repeatedly decreasing and displaying the current price;
receiving bids from bidders at the then-current price or lower and saving received bids in a database;
selecting a highest bid in the database not marked as winning;
comparing the highest bid to the then-current price and marking the highest bid as winning and decreasing a quantity of products when the highest bid equals or exceeds then-current price; and
awarding the product to bidders with bids marked as winning at the current price when at least one of the following occurs: i) the quantity of products equals zero, ii) the ending time of the auction is reached, and iii) the auction is manually stopped;
wherein a modified descending price auction is administered.

2. The method of claim 1, wherein manually stopping the auction is based on calculating, with the processor, a highest profit using the current price and the winning bids stored in the database.

3. The method of claim 1, wherein determining the rate of decrease in the current price includes one of a linear decrease rate, an exponential decrease rate, a logarithmic decrease rate, and a combination thereof.

4. The method of claim 1, wherein selecting the highest bid not marked as winning further includes comparing the selected highest bid to all other bids saved in the database to determine if any other bids are in the same amount.

5. The method of claim 4, further comprising selecting the highest bid that was received first in time when it has been determined that other bids are in the same amount.

6. A method comprising:
setting an initial current price for a quantity of the product, an auction starting time, and an auction ending time;
determining, with a processor, a rate of decrease in the current price;
instructing a display to display the current price and enabling bidding at the current price;
repeatedly decreasing and displaying the current price;
receiving bids from bidders at the then-current price or lower and saving received bids in a database;
comparing, for each received bid, the respective bid to the then-current price and reserving the bid and decreasing a quantity of products when the respective bid equals or exceeds the then-current price; and
awarding the product to bidders with reserved bids at the current price when at least one of the following occurs: i) the quantity of products equals zero, ii) the ending time of the auction is reached, and iii) the auction is manually stopped;
wherein a modified descending price auction is administered.

7. The method of claim 6, wherein manually stopping the auction is based on calculating, with the processor, a highest profit using the current price and the reserved bids stored in the database.

8. The method of claim 6, wherein determining the rate of decrease in the current price includes one of a linear decrease rate, an exponential decrease rate, a logarithmic decrease rate, and a combination thereof.

9. The method of claim 6, wherein comparing each received bid includes comparing the respective bid to all other bids saved in the database to determine if any other bids are in the same amount.

10. The method of claim 9, further comprising selecting the received bid that was received first in time when it has been determined that other bids are in the same amount.

11. A system configured to administer a modified descending price auction for a plurality of products over a network, comprising:
a database; and
at least one processor configured to execute program instructions and to process logic including;
setting an initial current price for a quantity of the product, an auction starting time, and an auction ending time;
determining, with the processor, a rate of decrease in the current price;
instructing a display to display the current price and enabling bidding at the current price;
repeatedly decreasing and displaying the current price;
receiving bids from bidders at the then-current price or lower and saving received bids in the database;
selecting a highest bid in the database not marked as winning;
comparing the highest bid to the then-current price and marking the highest bid as winning and decreasing a quantity of products when the highest bid equals or exceeds the then-current price;
awarding the product to bidders with bids marked as winning at the current price when at least one of the following occurs: i) the quantity of products equals zero, ii) the ending time of the auction is reached, and iii) the auction is manually stopped.

12. The system of claim 11, wherein manually stopping the auction is based on calculating, with the processor, a highest profit using the current price and the winning bids stored in the database.

13. The system of claim 11, wherein determining the rate of decrease in the current price includes one of a linear decrease rate, an exponential decrease rate, a logarithmic decrease rate, and a combination thereof.

14. The system of claim 11, wherein selecting the highest bid not marked as winning further includes comparing the selected highest bid to all other bids saved in the database to determine if any other bids are in the same amount.

15. The system of claim 14, further comprising selecting the highest bid that was received first in time when it has been determined that other bids are in the same amount.

16. A system configured to administer a modified descending price auction for a plurality of product over a network, comprising:
a database; and
at least one processor configured to execute program instructions and to process logic including;
setting an initial current price for a quantity of the product, an auction starting time, and an auction ending time;
determining, with the processor, a rate of decrease in the current price;
instructing a display to display the current price and enabling bidding at the current price;
repeatedly decreasing and displaying the current price;
receiving bids from bidders at the then-current price or lower and saving received bids in the database;
comparing, for each received bid, the respective bid to the then-current price and reserving the bid and decreasing a quantity of products when the respective bid equals or exceeds the then-current price; and
awarding the product to bidders with reserved bids at the current price when at least one of the following occurs: i) the quantity of products equals zero, ii) the ending time of the auction is reached, and iii) the auction is manually stopped.

17. The system of claim 16, wherein manually stopping the auction is based on calculating, with the processor, a highest profit using the current price and the reserved bids stored in the database.

18. The system of claim 16, wherein determining the rate of decrease in the current price includes one of a linear decrease rate, an exponential decrease rate, a logarithmic decrease rate, and a combination thereof.

19. The system of claim 16, wherein comparing each received bid includes comparing the respective bid to all other bids saved in the database to determine if any other bids are in the same amount.

20. The system of claim 19, further comprising selecting the received bid that was received first in time when it has been determined that other bids are in the same amount.
